(19) United States
(12) Patent Application Publication
(10) Pub. No.: US 2026/0315835 A1
(43) Pub. Date: Oct. 15, 2026

(54) Escape System

(71) Applicant: Clarence Cole, Birmingham (GB)

(72) Inventor: Clarence Cole, Birmingham (GB)

(21) Appl. No.: 19/101,004

(22) PCT Filed: Jul. 24, 2023
(86) PCT No.: PCT/GB2023/051949

§ 371 Date: Feb. 4, 2025

(30) Foreign Application Priority Data
Aug. 30, 2022 (GB) 2212524.9

(51) Int. Cl. A62B 1/20; A62B 1/02

(52) U.S. Cl. CPC A62B 1/20; A62B 1/02

(57) ABSTRACT

An escape system suitable for evacuating people from a multi-story building, the system comprising a chute, a first capsule and a second capsule, and a locking system.

### FIELD OF THE INVENTION

The present invention relates to the field of escape systems for evacuating people from upper levels of a multi-storey building down to a lower level, e.g. ground level. More specifically, the present invention relates to an escape system that can carry out such an evacuation safely and in a controlled manner using electromagnetic braking.

### BACKGROUND OF THE INVENTION

When designing a multi-storey building, such as a high-rise office block or residential unit, it is important to consider how occupants of the building will be evacuated in the case of an emergency, such as a fire or an earthquake.

Evacuation plans for buildings vary, but occupants are consistently warned against taking elevators in an emergency scenario. This is guard against a malfunction or loss of power rendering the lift immobile. Occupants are instead often advised to use stairs to evacuate from the building. These may be stairs provided for day-to-day access or may be purpose-built emergency exit stairs. However, stairwells can fill with toxic smoke that prevents passage. When using stairs to escape, the speed of descent can be limited by slow moving people ahead, and an overcrowded stairwell can lead to trip hazards. Stairwells also present difficulties in the evacuation of people with mobility issues, including the elderly; for parents with young children; and for people who experience difficulties with busy spaces.

US 2011/0061971 discloses an arrangement whereby an individual carrying means, e.g. involving a frame with a headrest and backrest to which a person is attached using a rescue suit with straps, is used to effect a rapid descent from a higher level to a lower level. A braking member, e.g. in the form of a fin, travels within a slot located between a row of permanent magnets. The braking member travelling through the slot disturbs the magnetic field and induces eddy currents, whereby a force opposite the direction of movement of the braking member is generated. This controls the speed of descent of the individual. However, this system only allows for the evacuation of one person at a time and so is not suitable for groups who would need to travel together, such as a parent together with their children. In addition, it is not suitable for people with mobility issues. Even for the able-bodied, the arrangement is not simple or quick to use and therefore is problematic in an emergency situation where people may be panicking.

CN 111840834 discloses an escape device with speed control comprising an escape pipe arranged in a spiral and an escape capsule. This system requires a large footprint of space outside the building to be usable, and its spiral design also makes it unsuitable for those who are of a nervous disposition and people with mobility issues. It does not provide a steady and well-controlled escape that can be easily used by multiple people.

CN 209997047 discloses an escape arrangement comprising a rescue capsule attached by a rope to a wheel which is in turn configured to drive the rotation of a magnet within a copper pipe. Descent of the capsule under gravity drives the rotation of the wheel, generating an opposing force that slows that descent of the capsule. This system is only designed to allow one capsule to move downwards at any one time.

### SUMMARY OF THE INVENTION

The present inventor recognised that there remains a need for an emergency evacuation system that is safe, steady and reliable, whereby the system can be readily used by all occupants of a building without difficulty, regardless of whether they are mobile, less mobile or wheelchair users, and including parents with children, the elderly, those of a nervous disposition and people with disabilities. The system should also allow groups of people to travel together, in order to increase efficiency of evacuation, and to allow those who might have difficulties to be helped by others, and to prevent panic that could otherwise be caused by individuals being isolated from friends or family. The system should be steady in its descent, to avoid aggravating or causing injuries that would provide an additional burden to emergency services. These features would also prevent the development of panic, which makes evacuation of a building less efficient.

The present invention provides an escape system suitable for evacuating people from a multi-storey building. The system comprises a chute comprising one or more walls defining a linear escape path that runs from a top end to a bottom end, wherein the chute includes two or more entry apertures at spaced apart locations along the length of the walls and an exit aperture located at or near the bottom end, and wherein the walls comprise: a first layer of non-ferromagnetic metal providing a complete electrical circuit around the escape path; an optional second layer which is a barrier layer; and a third layer of non-ferromagnetic structural material; where the first layer is positioned at the inner surface of the walls, the optional second layer (when present) is positioned between the first layer and the third layer, and the third layer is positioned at the outer surface of the walls. The system also comprises a first capsule and a second capsule, which are each sized and shaped such that they can be located within the escape path and can move down the escape path under the influence of gravity, wherein each capsule has a top, a bottom and side walls and provides an enclosed space for housing two or more people and further includes a door via which the enclosed space can be accessed. Each capsule is provided with a permanent magnet array, the permanent magnet array comprising one or more upper magnets positioned at or near the top of the capsule, and one or more lower magnets positioned at or near the bottom of the capsule, wherein the first capsule has upper magnets with the opposite polarity (north-south orientation) to the lower magnets of the second capsule, such that when the first and second capsules are located in the escape path, with the second capsule above the first capsule, the poles of the upper and lower magnets that are adjacent to each other are the same (both north, or both south) and thus act to repel the capsules away from each other. The system further comprises a locking system for releasably securing each capsule at a loading position in which the door of the capsule is aligned with an access hole in the chute walls.

The system is such that, in use, the chute can be aligned with the building so that each entry aperture aligns with a floor of the building, and the locking system can be used to secure the first capsule in a loading position whereby the door of the first capsule is aligned with a first entry aperture and a first corresponding floor of the building, and to secure the second capsule in a loading position whereby the door of the second capsule is aligned with a second entry aperture and a second corresponding floor of the building, and people in the building can enter the first and second capsules via their respective doors. The locking system can then be unlocked, to release the capsules from their loading positions, allowing the capsules to travel down the escape path under the influence of gravity.

Advantageously, the speed of downward travel is slowed in a controlled manner due to the magnet array moving through the electrical circuit around the escape path that is created by the first layer. A force is generated according to Lenz's Law that opposes the movement of the magnet array; this therefore acts as a breaking force which ensures the capsule does not free fall under gravity. The use of a magnet array comprising one or more upper magnets positioned at or near the top of the capsule and one or more lower magnets positioned at or near the bottom of the capsule means that there is greater control over the speed of descent and the downward movement of the capsule is steadier and more comfortable for the people inside the capsule.

The polarities of the magnets mean that like poles are adjacent to each other and thus the magnets act to repel the capsules away from each other. As the distance between the capsules decreases, the repulsion force between the capsules increases and they are kept apart. Therefore, multiple capsules can safely be used at the same time because they will not bump into each other. The combination of this feature and the ability to include multiple people in each capsule means that many more people can be evacuated more quickly, yet the system is still safe.

The system of the invention could be kept in position alongside a multi-storey building, ready for use, or it could be moved into position in the event of an emergency.

When the system is in position alongside a multi-storey building, the chute is aligned with the building so that each entry aperture aligns with a floor of the building. The locking system is used to secure the first capsule in a loading position whereby the door of the first capsule is aligned with a first entry aperture and a first corresponding floor of the building, and to secure the second capsule in a loading position whereby the door of the second capsule is aligned with a second entry aperture and a second corresponding floor of the building. In a building with twenty floors, for example, a first capsule could be aligned with the 10^{th} floor and a second capsule could be aligned with the 15^{th} floor. Those people on floors without a capsule could make their way down to the nearest floor with a capsule or could exit using conventional emergency exit staircases if they were on floors below the lowest capsule.

People would enter into the capsule via the aligned entry aperture and door. The capsule's housing area may be designed for standing only, such as in a conventional elevator, or seating may be provided within the capsule. Once the capsule is at capacity, or when there are no more people waiting to load into the capsule, the locking system can then be unlocked. This will release the capsule from its loading position, allowing the capsule to travel down the escape path under the influence of gravity, but slowed by the braking force described above. Therefore, groups of people can safely and steadily descend down to ground level.

When the first capsule reaches the exit aperture, people can disembark. The capsule door can align with the exit aperture and people can exit via the door and exit aperture. It may be that the exit aperture leads directly to ground level, or it may be that a walkway is connected to the exit aperture. It may be that the exit aperture is sized and shaped such that the capsule itself can be removed from the chute through the exit aperture, e.g. by use of a conveyor or pulley system, and that people exit via the capsule door only once the capsule has been moved out of the chute.

In one embodiment, there is a single exit aperture, and this is sized and shaped such that each capsule can be removed from the chute through the exit aperture. In this embodiment, when the first capsule reaches the exit aperture, the second capsule will be positioned above the first capsule (being repelled by the upper magnets of the first capsule) until the first capsule is removed from the chute. Then the second capsule will descend further (under gravity but slowed by the braking force) until it reaches the exit aperture, and people can disembark in the same manner as discussed above for the first capsule.

In an alternative embodiment, there is an exit aperture per capsule. In this embodiment, when the first capsule reaches the first exit aperture, the second capsule is positioned above the first capsule (being repelled by the upper magnets of the first capsule) and is aligned with the second exit aperture. The second capsule door can align with the second exit aperture and people can exit via the door and the exit aperture. The second exit aperture may connect to a walkway, via which people can reach ground level.

Therefore, by use of the system of the invention, large numbers of people can be safely evacuated in a quick, safe and efficient manner from higher levels of a multi-storey building to lower levels, e.g. ground level.

### DETAILED DESCRIPTION OF THE INVENTION

The system is arranged such that, in use, the capsules are positioned within the chute. When the locking system is unlocked, each capsule is free to travel and passes down through the chute under gravity.

As each capsule descends under gravity, within the chute a braking force is generated in accordance with Lenz's Law, which states that the current induced in a circuit due to a change in a magnetic field is directed to oppose the change in flux and to exert a mechanical force which opposes the motion.

When referring to the components of the system, the top end is the end that, in use, is furthest from the ground, and the bottom end is the end that, in use, is closest to the ground. The length of a component will be along the axis defined between the top and bottom ends. The perimeter of a component is the perimeter of a cross section of the component perpendicular to the length.

The polarity of a magnet refers to the orientation of the north and south poles of the magnet in space.

In the present invention, each capsule is provided with a permanent magnet array, the permanent magnet array comprising one or more upper magnets positioned at or near the top of the capsule, and one or more lower magnets positioned at or near the bottom of the capsule. When there are a plurality of upper magnets positioned at or near the top of the capsule, each upper magnet should have the same polarity (north-south orientation), so that the north poles are all aligned at one end and the south poles are all aligned at another end. When there are a plurality of lower magnets positioned at or near the bottom of the capsule, each lower magnet should have the same polarity (north-south orientation), so that the north poles are all aligned at one end and the south poles are all aligned at another end.

In the present invention, the first capsule has upper magnets with the opposite polarity (north-south orientation) to the lower magnets of the second capsule, such that when the first and second capsules are located in the escape path, with the second capsule above the first capsule, the poles of the upper and lower magnets that are adjacent to each other are the same (i.e. both north, or both south) and thus act to repel the capsules away from each other.

### Chute

The system includes a chute comprising one or more walls defining a linear escape path that runs from a top end to a bottom end. The walls comprise: a first layer of non-ferromagnetic metal providing a complete electrical circuit around the escape path; an optional second layer which is a barrier layer; and a third layer of non-ferromagnetic structural material; where the first layer is positioned at the inner surface of the walls, the optional second layer (when present) is positioned between the first layer and the third layer, and the third layer is positioned at the outer surface of the walls.

The first layer forms part of the braking system of the escape system. As noted above, the first layer of the chute wall is constructed from a non-ferromagnetic material and forms a complete electrical circuit around the escape path. As the capsule passes through this complete electrical circuit, it changes the magnetic flux and a current is generated. According to Lenz's law, the direction of the current is such that it in turn generates a magnetic field in opposition to the charge that created it. This opposing magnetic field slows the descent of the capsule and will be referred to as the braking force.

The size of the braking force is determined by the resistance in the circuit and the size of the magnetic field passing through it. Lower resistance in the circuit results in a greater braking force. A greater magnetic field also results in a greater braking force.

The first layer is formed from a non-ferromagnetic material and this can be chosen by the skilled person to provide a suitable braking force for the system. As the skilled person will appreciate, by using a material with low resistivity an effective braking force can be achieved, so as to achieve a steady descent for the capsule.

In some embodiments, the material used to form the first layer has a resistivity at 20° C. of 1×10⁻⁷ Ω·m or less. For example, in some embodiments the resistivity of the material may be 9×10⁻⁸ Ω·m or less, or 8×10⁻⁸ Ω·m or less, or 6×10⁻⁸ Ω·m or less, or 3×10⁻⁸ Ω·m or less, such as 2×10⁻⁸ Ω·m or less. Resistivity may be measured according to ASTM B 193-20.

The skilled person will appreciate that non-ferromagnetic materials are materials that are non-magnetic and do not contain iron. In some embodiments, the non-ferromagnetic material of the first layer is silver, copper, gold, aluminium, tungsten, zinc, or nickel, or combinations thereof. Alloys based on these metals may be contemplated, e.g. copper-nickel alloys.

In one embodiment the non-ferromagnetic material has a purity of 95 wt % or more, such as 99 wt % or more, or 99.8 wt % or more. In one preferred embodiment, the non-ferromagnetic material is copper, such as copper having a purity of 99 wt % or more.

In some embodiments, the first layer is present as a continuous layer along the length of the chute.

However, it is envisaged that the first layer could alternatively be a discontinuous layer along the length of the chute, provided that it still forms a complete electrical circuit around the escape path.

For example, in some embodiments the first layer is provided as a series of bands arranged at intervals along the length of the chute. The material, spacing and length of these bands can be chosen by the skilled person to provide sufficient braking force as the escape capsule passes through the chute. For example, the bands may be shorter and/or with a wider spacing towards the top end of the chute and may be longer and/or with a narrower spacing towards the lower end of the chute. Such an arrangement would allow an escape capsule to initially descend along the escape path at a higher speed before being gradually slowed by an increasing braking force as it approaches the bottom of the escape path. In essence, the more non-ferromagnetic material that is present as the first layer, the greater the braking force that is provided and therefore gaps will reduce the braking force and increase the capsule speed.

The non-ferromagnetic material could include more than one material and the amounts of each material can be changed to achieve a desired level of braking, e.g. there could be more aluminium where minimum braking is required, and more copper where maximum braking is required. It may be that the first layer comprises bands of copper interspersed with bands of aluminium and/or tungsten, wherein the aluminium and/or tungsten bands are taller than the copper bands where minimum braking is needed, and shorter than the copper bands where maximum braking is needed.

In some embodiments, the first layer has a thickness of from 0.05 to 2 metres. For example, in some embodiments the first layer has a thickness of from 0.1 to 1.5 metres, from 0.2 to 1 metres, from 0.3 to 0.9 metres, or from 0.4 to 0.8 metres. The thickness of the first layer may vary along the length of the chute, to provide sufficient braking force as the escape capsule passes through the chute. For example, the first layer may be thinner towards the top of the chute and thicker towards to bottom of the chute. As with the above embodiment, such an arrangement would allow an escape capsule to initially descend along the escape path at a higher speed before being gradually slowed by an increasing braking force as it approaches the bottom of the escape path. For example at least 5 metres, such as from 5 to 15 metres or from 5 to 10 metres, of the first layer extending upwards from the bottom end of the chute may have a thickness of from 0.5 metres to 2 metres, such as from 1 to 2 metres, to provide maximum breaking. Optionally in this example at least 5 metres, such as from 5 to 15 metres or from 5 to 10 metres, of the first layer extending upwards from the bottom end of the chute may comprise or consist of copper.

For example, the first layer may comprise one or more bands of tungsten with a thickness of from 0.2 to 1 metres, optionally interspersed with bands of copper of the same thickness, towards the top end of the chute where minimum braking is needed, and comprises one or more bands of copper towards the bottom end of the chute where maximum braking is needed, wherein the one or more bands of copper towards the bottom end of the chute have a thickness of from 1 to 2 metres.

The design of a suitable continuous or discontinuous first layer is within the abilities of the skilled person, taking into account the desired braking force and costs of the materials involved.

The optional second layer is a barrier layer. This layer is usefully included in some embodiments of the invention to reduce or prevent corrosion and decay of the first layer. Such corrosion or decay could otherwise occur due to exposure to environmental factors. Such environmental factors include, but are not limited to, weathering, corrosion, and chemical interaction with the third layer.

A barrier layer may also be included in embodiments of the invention in order to assist with ease of manufacture for the chute.

The skilled person would understand that the second layer is not essential, because a barrier is not always required. For example, a barrier is not needed when corrosion and decay of the first layer is already sufficiently limited to acceptable/tolerable levels, due to the selection of materials for the first and third layers and/or the arrangement of these layers.

In one embodiment, the first layer consists of aluminium, the third layer consists of ceramic, and the first layer is completely encapsulated within the third layer; in this embodiment a barrier layer is not needed for reducing/preventing corrosion and decay.

The skilled person could of course still choose to include a barrier layer, and this is not precluded.

In some embodiments the barrier material is selected from plastic, glass, ceramic or combinations thereof. Suitable plastics include, but are not limited to, polyethylene, polycarbonate, acrylic, polypropylene, polytetrafluoroethylene, polyacrylate, resins, combinations thereof. In some embodiments the barrier material is fibreglass.

The third layer is a non-ferromagnetic structural material arranged on the exterior of the chute. A function of the third layer is to strengthen the chute such that it can support the weight of the other components of the system. Another function of the third layer is to protect the system such that the useful lifetime of the system is extended.

The skilled person will appreciate that non-ferromagnetic materials are materials that are non-magnetic and do not contain iron. In one embodiment the third layer is selected from concrete, brick, stone, cement, ceramic, or combinations thereof.

The chute may have any cross-sectional shape suitable to allow the passage of the escape capsule. However, a regular shape is preferred in terms of ease of manufacture. For example, the cross section of the chute perpendicular to its length may be circular, square, rectangular or hexagonal.

The chute defines a linear escape path and thus the chute is straight along its length. In use, the chute may suitably be provided in a vertical orientation, perpendicular to the ground. However, it is envisaged that in use the chute could alternatively be angled to be off-vertical e.g. at an angle of up to 30 degrees to vertical (such as up to 20 or up to 10 or up to 5 degrees to the vertical), provided that gravity is able to act on the capsules such that they move through the chute from a higher level to a lower level.

The chute has two or more entry apertures at spaced apart locations along the length of the walls. The entry apertures will, in use, align with locations in the multi-storey building where people can exit the building and access the escape system. In one embodiment, these entry apertures are permanently open. In another embodiment, one or more of these entry apertures can be closed by one or more doors. These one or more doors may be configured to complete the circuit of the first layer; however, this is not essential for the function of the escape system provided the first layer forms a circuit elsewhere along the length of the chute to provide sufficient braking force during the passage of a capsule.

The chute may have more than two entry apertures, for example three or more, or four or more, or five or more; in one embodiment there are from two to twenty entry apertures. The skilled person will appreciate that increasing the number of entry apertures increases the number of locations in the multi-storey building where people can exit the building and access the escape system. The entry apertures should of course be spaced along the length of the chute walls such that they can, in use, align with a location in the multi-storey building where people can exit the building.

The chute also has an exit aperture located at or near the bottom end. The exit aperture will, in use, provide a location where people can exit the escape system and access a lower level, e.g. ground level. In one embodiment, the exit aperture is permanently open. In another embodiment, the exit aperture can be closed by a door. The door may be configured to complete the circuit of the first layer; however, this is not essential for the function of the escape system provided the first layer forms a circuit elsewhere along the length of the chute to provide sufficient braking force during the passage of a capsule.

The chute may have more than one exit apertures, for example two or more or three or more. As discussed above, in one embodiment there is an exit aperture per capsule. The first exit aperture may directly access ground level or may access a walkway; the second and any further exit apertures can access a walkway, via which people can reach ground level.

The chute is, in use, positioned adjacent to the multi-storey building which the escape system serves. In one embodiment, the chute is directly and permanently in contact with the building. In another embodiment the chute is indirectly connected to the structure, e.g. via supporting struts, but is otherwise spaced from the building. In yet another embodiment, the chute can be moved into and out of contact with the building, e.g. by the use of a hydraulic system. In yet another embodiment, the chute is permanently free standing, located away from the building.

The bottom end of the chute may, in use, be positioned at ground level. However, it could be that the bottom end of the chute is positioned at an elevated level, e.g. first floor level, or a raised platform. The skilled person will appreciate that what is important is that the escape system allows people to escape down to a level where they can safely and readily evacuate away from the building.

Likewise, any walkways that lead from an exit aperture may provide direct access to ground level, or they may provide access to an elevated level, e.g. first floor level, or a raised platform. What is important is facilitating escape down to a level where people can safely and readily evacuate away from the building.

The top end of the chute may, in use, be positioned at the top of the multi-storey building, or it may be at any other elevated location. The skilled person will appreciate that what is important is that the entry apertures will, in use, align with locations in the multi-storey building where people can exit the building and access the escape system.

In a building with twenty floors, for example, a first entry aperture could be aligned with the 10^{th} floor and a second entry aperture could be aligned with the 15^{th} floor. Those people on floors without an entry aperture could make their way down to the nearest floor with an entry aperture or could exit using conventional emergency exit staircases if they were on floors below the lowest entry aperture.

### Capsules

The system comprises a first capsule and a second capsule. These are each sized and shaped such that they can be located within the escape path and can move down the escape path under the influence of gravity.

Each capsule has a top, a bottom and side walls and provides an enclosed space for housing two or more people, such as four people, six people, eight people, or ten people, or more. In one embodiment, the enclosed space may be suitable for housing up to 50 people, or up to 25 people, e.g. from 4 to 20 people.

The enclosed space may be suitable for housing standing people, seated people, prone people, or any combination thereof. In one embodiment, the enclosed space is provided with seating, e.g. benches and/or wall-mounted fold-up seats. In another embodiment, the enclosed space is standing room only. The enclosed space may be provided with grab handles, handrails and/or stanchions.

The escape capsule may have a floor space of 0.5 m² or more, or 1 m² or more, or 2 m² or more, or 3 m² or more, or 4 m² or more. The escape capsule may, for example, have a floor space of from 0.5 to 10 m², from 1 to 9 m², from 1.5 to 8 m², or from 2 to 6 m².

Each capsule further includes a door via which the enclosed space can be accessed. Any suitable design of door may be used, but it could be envisaged that there may, for example, be a sliding door.

Each capsule is provided with a permanent magnet array. The magnet array provides a breaking force as it passes through the chute. The permanent magnet array comprises one or more upper magnets positioned at or near the top of the capsule, and one or more lower magnets positioned at or near the bottom of the capsule.

The first capsule has upper magnets with the opposite polarity (north-south pole orientation in space) to the lower magnets of the second capsule, such that when the first and second capsules are located in the escape path, with the second capsule above the first capsule, the magnets act to repel the capsules away from each other. In this regard, the poles of the upper and lower magnets that are adjacent to each other are the same (both north, or both south) and thus act to repel the capsules away from each other.

A permanent magnet is a material that creates its own persistent magnetic field. In one embodiment the permanent magnets of the magnet array are rare-earth magnets, preferably neodymium magnets, samarium-cobalt magnets or combinations thereof. In one preferred embodiment, the magnets are neodymium magnets. These are particularly beneficial in terms of creating an effective braking force and resulting in a comfortable and smooth journey for people in the capsules. As the skilled person will be aware, neodymium magnets come in various grades, which indicate their strength; the higher the number, the stronger the magnet. For example, grades N35, N38, N40, N42, N45, N48, N50 and N52 are available.

It may be that each permanent magnet array comprises three or more upper magnets (such as four or more, or five or more) positioned at or near the top of the capsule, and three or more lower magnets (such as four or more, or five or more) positioned at or near the bottom of the capsule.

In one embodiment, the upper magnets in the magnet array are spaced in an equidistant manner about a central elongate axis and/or the lower magnets in the magnet array are spaced in an equidistant manner about a central elongate axis.

In general, it may be desired that the arrangement of the upper magnets is evenly spaced and symmetrical and/or it may be desired that the arrangement of the lower magnets is evenly spaced and symmetrical. Such arrangements assist with the capsules traveling down the chute in a smooth and steady manner, which makes the escape process usable for a range of people, including the elderly and those with physical disabilities and including those of a nervous disposition.

In a preferred embodiment, each capsule has the same number of upper magnets and lower magnets (e.g. four upper magnets and four lower magnets). It is preferred that the upper magnets are positioned and spaced at or near the top of the capsule in an arrangement which mirrors the positioning and spacing of the lower magnets at or near the bottom of the capsule. Such a symmetrical arrangement will assist with the capsules traveling down the chute in a smooth and steady manner, which makes the escape process usable for a range of people, including the elderly and those with physical disabilities and including those of a nervous disposition.

In one embodiment, each permanent magnet array comprises one or more, such as two or more or three or more, additional permanent magnets located between the upper magnets and the lower magnets. For example, each magnet array may comprise from two to 20 additional permanent magnets, such as from two to 10 additional permanent magnets, e.g. from 3 to 8 additional permanent magnets. When present, additional permanent magnets in the magnet array provide additional breaking force as the escape capsule passes through the chute.

It may suitably be that the additional magnets in the magnet array are spaced in an equidistant manner about a central elongate axis. This means that the magnetic field produced by the additional permanent magnets is evenly distributed and this improves the stability of the capsule as it descends down the chute. Improved stability of the escape capsule leads to improved safety and comfort for people within the capsule, thereby reducing panic and preventing the aggravation of injuries, both of which would reduce the efficiency of an evacuation.

According to Faraday's law of induction:

$$ε = - \frac{{δΦ}_{B}}{δ t}$$

where ε is electromotive force, O_{B} is magnetic flux, O_{B}=BS Cos0. S is the area of the surface.

By calibrating the size of the magnets and resistance of the circuit to the weight of the capsules the maximum velocity of the capsules when in free fall can be constrained to within a desired range. The desired maximum velocity would vary depending on the height of the building, the number of capsules in the system and the distance between the capsules. A suitable range for the descent velocity would be in the range from 0.1 to 15 m/s, for example from 0.2 to 13 m/s or from 0.5 to 10 m/s or from 1 to 8 m/s. In some embodiments, the descent velocity would be in the range from 0.1 to 10 m/s, for example from 0.2 to 10 m/s or from 0.5 to 8 m/s or from 0.5 to 5 m/s. In preferred examples, the maximum velocity during descent is from 0.5 to 5 m/s, and most preferably from 0.5 to 3 m/s. A skilled person would be able to calibrate the system to provide the amount of braking force required for safe descent of the escape capsule, depending on the size of the system and the number of people to be evacuated in each escape capsule.

The skilled person would be able to select suitable magnets to achieve the effect of repelling the adjacent capsule and providing a braking force.

Each capsule may be constructed from any suitable material. The skilled person will appreciate that the capsule needs to be robust but relatively lightweight. In one embodiment, each capsule is constructed from materials selected from fibre glass, toughened glass, plastics (such as polyethylene or polycarbonate), steel, aluminium, magnesium alloys, titanium, and combinations thereof.

Each capsule is sized and shaped such that it can be located within the escape path and can move down the escape path under the influence of gravity. Each capsule may have the same cross-sectional shape as the chute, or it may have a different shape, provided that it can fit within and move down the escape path. In one embodiment, the capsules are cuboid or cylindrical in shape.

In some embodiments, each capsule may be provided with electric lights. These lights may be battery powered. The lights may be automatic, such that they turn on when the environment is dark and turn off when the environment is bright. Whilst not essential, the provision of a lighting system makes the escape system easier to use, may reduce feelings of panic and claustrophobia that may otherwise be experienced by people in the capsule, and may facilitate rescue from the capsule by the emergency services if necessary.

The system is described in relation to an embodiment comprising first and second capsules. However, the presence of further capsules is not precluded, and embodiments can be envisaged where there are more than two capsules, e.g. where there are three or four of five or more capsules.

When the system comprises a third capsule (and any further capsules), these are each sized and shaped such that they can be located within the escape path and can move down the escape path under the influence of gravity, wherein each capsule has a top, a bottom and side walls and provides an enclosed space for housing two or more people and further includes a door via which the enclosed space can be accessed. Each capsule is provided with a permanent magnet array, the permanent magnet array comprising one or more upper magnets positioned at or near the top of the capsule, and one or more lower magnets positioned at or near the bottom of the capsule.

The second capsule should have upper magnets with the opposite polarity (north-south pole orientation in space) to the lower magnets of the third capsule, such that when the second and third capsules are located in the escape path, with the third capsule above the second capsule, the magnets act to repel the capsules away from each other. In this regard, the poles of the upper and lower magnets that are adjacent to each other are the same (both north, or both south) and thus act to repel the capsules away from each other.

In general, the nth capsule should have upper magnets with the opposite polarity (north-south pole orientation in space) to the lower magnets of the (n+1)th capsule, such that when the nth and (n+1)th capsules are located in the escape path, with the (n+1)th capsule above the nth capsule, the magnets act to repel the capsules away from each other. In this regard, the poles of the upper and lower magnets that are adjacent to each other are the same (both north, or both south) and thus act to repel the capsules away from each other.

In other words, the capsules should, in use, be arranged within the escape path such that the upper magnets on one capsule have the opposite polarity to the adjacent lower magnets on the next capsule, so that the magnets act to repel the capsules away from each other, due to the adjacent poles being the same (both north, or both south).

### Locking System

The system further comprises a locking system for releasably holding each escape capsule in a stationary position within the chute. The locking system secures the escape capsule such that the door of the escape capsule aligns with an access point in the chute.

Locking systems are known in the art and can be used in the present invention.

In one embodiment, the locking system comprises a plurality of releasable hydraulic clamps. These clamps may suitably be secured to the capsules. When the clamps are engaged, they act to hold each escape capsule in a stationary position within the chute. Upon release of the clamps, the capsule can move.

In an alternative embodiment, the locking system comprises a gear and track system. In this regard, one or more gears may be releasably fixed to the capsule (e.g. by an axel). Thus the gears can be releasably fixed at a location, holding each escape capsule in a stationary position within the chute. Upon release of the gears, the capsule can move. In particular, in the released position, the gears can rotate freely (e.g. about the axel) to allow the capsule can move. Each gear can run along a track provided within the chute interior; in particular, each gear may have teeth that are engaged with the teeth of a track running along the length of the chute interior.

The locking system may be configured to be controlled from within the capsule, or from outside of the capsule, or both. In one embodiment, the locking system is configured such that a person inside the capsule can lock and unlock the locking system. In another embodiment, the locking system is configured for remote control, e.g. by the emergency services, or by a person within the multi-storey building (such as a ground-floor receptionist), or by a control centre. In one embodiment, there are multiple options for control of the locking system, preventing a failure of one option from causing the escape system to become inoperable.

### Optional Features

In some embodiments, the escape system further comprises one or more walkway to facilitate passage from the multi-storey building to an entry aperture in the chute. It may be that each entry aperture is associated with a walkway.

In some embodiments, the escape system further comprises one or more walkway to facilitate passage away from an exit aperture in the chute. Such a walkway may provide direct access to ground level, or they may provide access to an elevated level, e.g. first floor level, or a raised platform. What is important is facilitating escape down to a level where the person can safely and readily evacuate away from the building.

The walkway may be permanently positioned to allow passage to or from the escape system, or it may be moveable, e.g. via a hydraulic system, into position when needed.

In some embodiments, the escape system further comprises a system to remove a capsule from the chute through the exit aperture. The system may, for example, be a conveyor or pulley system. Thus, in use, the capsule is pulled out from, and to the side of, the chute once it has reached the bottom end of the chute. People will then exit via the capsule door once the capsule has been moved out of the chute.

The skilled person will appreciate that where a pulley system is present, the capsules should be configured to allow attachment to the pulley.

In some embodiments, the escape system further comprises a winch system configured to lift a capsule back into position after use. In one embodiment, the capsule is located inside the chute and the winch system is configured to lift the capsule up along the escape path until the desired position is reached. In another embodiment, the capsule has been pulled out to the side of the chute and the winch system is configured to lift the capsule up outside the chute before being placed in the top end of the chute and lowered down the escape path until the desired position is reached.

The winch system may, for example, be battery operated. The batteries may optionally be charged from a mains supply or may be charged by a direct connection to solar panels.

The skilled person will appreciate that where a winch system is present, the capsules should be configured to allow attachment to the winch.

A combined winch and pulley system could be contemplated, that both pulls a capsule out from, and to the side of, the chute once it has reached the bottom end of the chute and then once the people have left the capsule it lifts the capsule up outside the chute before being placed in the top end of the chute and lowered down the escape path until the desired position is reached.

In some embodiments, the escape system further comprises a sprinkler system. This may be positioned to deliver water to those parts of the escape system that are closest to the multi-storey building. For example, it may in particular target water to the entry apertures and/or any walkways associated with entry apertures. The sprinkler system may suitably deliver water through nozzles fed from a storage tank or from a mains water supply.

In some embodiments, the escape system further comprises a braking component located at or near the bottom end of the chute, the braking component being configured to stop a capsule when it is in alignment with the exit aperture. The braking component may, for example, be selected from the group consisting of: one or more permanent magnet having opposite polarity to the lower magnets of the capsule; a spring plate; a hydraulicly sprung plate; and combinations thereof.

### DESCRIPTION OF THE DRAWINGS

Embodiments of the present invention will now be described, by way of example only, with reference to the accompanying drawings, in which:

FIG. 1 is a cross section of a chute suitable for use in an escape system of the present invention;

FIG. 2 is a side view of a capsule suitable for use in an escape system of the present invention;

FIG. 3A is a side view of an embodiment of the escape system of the present invention; and

FIG. 3B is a cross section of the escape system of FIG. 3A.

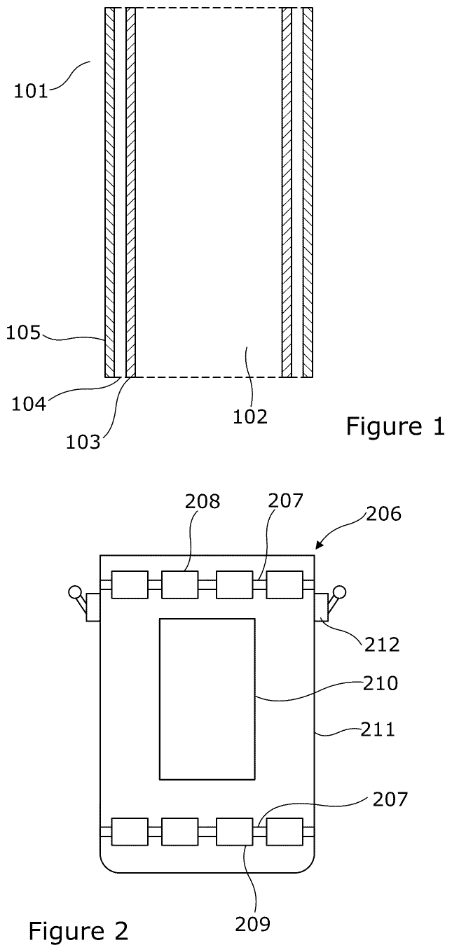

FIG. 1 shows a chute 101 suitable for use in the escape system of the invention. The chute 101 comprises walls defining a linear escape path 102 that runs from a top end 101b to a bottom end 101a of the chute 101. The chute 101 has walls formed of a first layer, a second layer and a third layer. The first layer 103 is a non-ferromagnetic metal arranged on the inner surface of the chute walls. This first layer 103 forms a complete electrical circuit around the escape path 102. The second layer 104 is optional and can be omitted, but when present is a barrier material and is located between the first and third layers. The third layer 105 is a non-ferromagnetic structural material arranged on the outer surface of the chute walls.

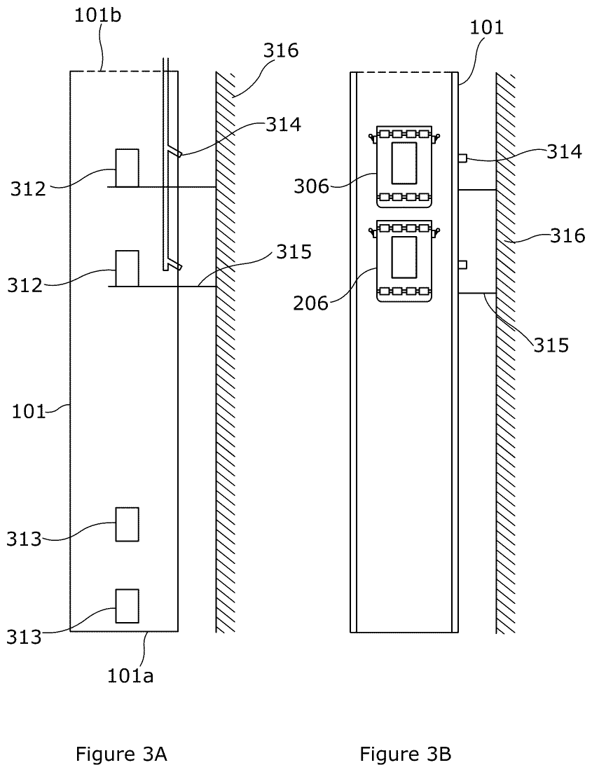

As can be seen in FIG. 3A, the chute includes two entry apertures 312 at spaced apart locations along the length of the walls and two exit apertures 313 located at or near the bottom end 101a.

FIG. 2 shows the exterior of a capsule 206 suitable for use in the escape system of the invention. The capsule 206 is sized and shaped such that it can be located within the escape path 102 and can move down the escape path 102 under the influence of gravity. The capsule 206 has a top, a bottom and side walls and provides an enclosed space for housing two or more people.

The capsule 206 further includes a door 210 via which the enclosed space can be accessed.

The capsule 206 is provided with a magnet array 207. The magnet array comprises multiple upper magnets 208 positioned at or near the top of the capsule, and multiple lower magnets 209 positioned at or near the bottom of the capsule.

The claimed escape system includes a first capsule 206 and a second capsule 306, as can be seen in FIG. 3B. The second capsule 306 is the same as the first capsule 206 except that it is required that the first capsule 206 has upper magnets 208 with the opposite polarity (north-south orientation) to the lower magnets 209 of the second capsule 306, such that when the first and second capsules 206, 306 are located in the escape path, with the second capsule 306 above the first capsule 206, the magnets act to repel the capsules away from each other. In this regard, the poles of the upper magnets 208 and lower magnets 209 that are adjacent to each other are the same (i.e. both north, or both south) and thus act to repel the capsules 206, 306 away from each other.

FIG. 2 also shows the locking system 212 for releasably securing capsule 206 at a loading position in which the door 210 of the capsule is aligned with an entry aperture 312 in the chute walls. This locking system 212 comprises a plurality of releasable hydraulic clamps. These clamps are secured to the capsule 206.

FIGS. 3A and 3B show an embodiment of the escape system in use, having been positioned alongside a multi-storey building 316.

In use, people would evacuate from upper levels of the building 316 at evacuation points in the building (not shown), using walkways 315 to reach the entry apertures 312 in the chute. In the illustrated embodiment, the walkways 315 are protected from fire by sprinkler system 314, which is positioned to douse any flames that might otherwise prevent access to or use of the walkways 315.

Escape capsules 206, 306 are arranged within the escape path 102 and are locked in position using locking system 212 in a location where they are each aligned with an entry aperture 312. These positions are shown in FIG. 3B.

The entry apertures 312 in the chute are therefore each aligned with a floor of the multi-storey building 316 and with a capsule 206, 306. Thus, people evacuating the building 316 can pass along the walkway 315, to an entry aperture 312 and then into an escape capsule 206, 306 via the capsule door 210.

The locking system 212 can then be released/unlocked to allow the capsules 206, 306 to travel down the escape path 102.

The capsules 206, 306 travel downward under the force of gravity but their speed is controlled due to the braking force generated. In this regard, the speed of downward travel is slowed in a controlled manner due to the magnet array 207 moving through the electrical circuit that is created by the first layer 103. A force is generated according to Lenz's Law that opposes the movement of the magnet array 207; this therefore acts as a breaking force which ensures the capsule 206, 306 does not free fall under gravity. The use of a magnet array 207 comprising upper magnets 208 positioned at or near the top of the capsule and lower magnets 209 positioned at or near the bottom of the capsule 206, 306 means that there is greater control over the speed of descent and the downward movement of the capsule 206, 306 is steadier and more comfortable for the people inside the capsule.

The first capsule 206 reaches the bottom end 101a of the escape path 102 and the door 210 is aligned with the lowermost exit aperture 313. People housed within the first capsule 206 will then be able to disembark via the door 210 and the exit aperture 313 to reach ground level and move to safety.

The second capsule 306 approaches the bottom end 101a of the escape path 102. The upper magnets 208 of the first capsule 206 have the opposite polarity to the lower magnets 209 of the second capsule 306, and thus the poles of the upper magnets 208 and lower magnets 209 that are adjacent to each other are the same (i.e. both north, or both south) and so act to repel the capsules 206, 306 away from each other. Therefore, the second capsule remains above the first capsule and does not collide with it. The door 210 of the second capsule 306 is aligned with the higher exit aperture 313. People housed within the second capsule 306 will then be able to disembark via the door 210 and the exit aperture 313 to reach a level that is close to ground level, and from there can move to safety, e.g. via a walkway (not shown).

It will be appreciated that in an alternative embodiment, there could be just a single exit aperture 313 but that this would be large enough that the entire capsule 206, 306 can exit. Thus the first capsule 206 would reach the bottom end 101a of the escape path 102 and would then be moved out of the escape path 102 via the exit aperture 313, e.g. using a pulley or conveyor system (not shown). People housed within the first capsule 206 will then be able to disembark via the door 210 to reach ground level and move to safety. The second capsule 306 would then reach the bottom end 101a of the escape path 102 and this capsule 306 would in turn be moved out of the escape path 102, e.g. using a pulley or conveyor system. People housed within the second capsule 306 will then be able to disembark via the door 210 to reach ground level and move to safety.

The escape system of the invention is safe, steady and reliable, and can be readily used by all occupants of a building without difficulty, regardless of whether they are mobile, less mobile or wheelchair users, and including parents with children, the elderly, those of a nervous disposition and people with disabilities. The system allows groups of people to travel together, in order to increase efficiency of evacuation, and allows those who might have difficulties to be helped by others. It also prevents panic that could otherwise be caused by individuals being isolated from friends or family. The system is also steady and comfortable in its descent, thereby not aggravating or causing injuries that would provide an additional burden to emergency services, and meaning it can be used by people having a nervous disposition.

1. An escape system suitable for evacuating people from a multi-story building, the system comprising:
a chute comprising one or more walls defining a linear escape path that runs from a top end to a bottom end, wherein the chute includes two or more entry apertures at spaced apart locations along the length of the walls and an exit aperture located at or near the bottom end, and wherein the walls comprise: a first layer of non-ferromagnetic metal providing a complete electrical circuit around the escape path; an optional second layer which is a barrier layer; and a third layer of non-ferromagnetic structural material; where the first layer is positioned at the inner surface of the walls, the optional second layer is, when present, positioned between the first layer and the third layer, and the third layer is positioned at the outer surface of the walls,
a first capsule and a second capsule, which are each sized and shaped such that they can be located within the escape path and can move down the escape path under the influence of gravity, wherein each capsule has a top, a bottom and side walls and provides an enclosed space for housing two or more people and further includes a door via which the enclosed space can be accessed; whereby each capsule is provided with a permanent magnet array, the permanent magnet array comprising one or more upper magnets positioned at or near the top of the capsule, and one or more lower magnets positioned at or near the bottom of the capsule, wherein the first capsule has upper magnets with the opposite polarity to the lower magnets of the second capsule, such that when the first and second capsules are located in the escape path, with the second capsule above the first capsule, the magnets act to repel the capsules away from each other; and
a locking system for releasably securing each capsule at a loading position in which the door of the capsule is aligned with an entry aperture in the chute walls.

2. The system of claim 1, wherein each capsule has the same number of upper magnets and lower magnets, and the upper magnets are positioned and spaced at or near the top of the capsule in an arrangement which mirrors the positioning and spacing of the lower magnets at or near the bottom of the capsule.

3. The system of claim 1, wherein the chute is cylindrical.

4. The system of claim 1, wherein each permanent magnet array comprises three or more upper magnets positioned at or near the top of the capsule, and three or more lower magnets positioned at or near the bottom of the capsule.

5. The system of claim 1, wherein each permanent magnet array comprises one or more, such as two or more or three or more, additional permanent magnets located between the upper magnets and the lower magnets.

6. The system of any one of claim 1, wherein the upper magnets in the magnet array are spaced in an equidistant manner about a central elongate axis and/or the lower magnets in the magnet array are spaced in an equidistant manner about a central elongate axis and/or the additional magnets in the magnet array are spaced in an equidistant manner about a central elongate axis.

7. The system of claim 1, wherein the magnet array comprises permanent magnets selected from the group consisting of: rare-earth magnets, such as neodymium magnets; samarium-cobalt magnets; and combinations thereof.

8. The system of claim 1, wherein each capsule can hold up to 50 people, e.g. from 4 to 20 people.

9. The system of claim 1, wherein the locking system comprises releasable hydraulic clamps permanently attached to each escape capsule or comprises a gear and track system.

10. The system of claim 1, wherein the system further comprises a pulley system arranged to remove a capsule from the bottom end of the chute via the exit aperture and to return it to the top end of the chute.

11. The system of claim 1, wherein the first layer is formed from a metal selected from the group consisting of: silver, copper, gold, aluminum, tungsten, zinc, nickel, and combinations thereof.

12. The system of claim 1, wherein the second layer is formed from a material selected from the group consisting of: plastic, glass, ceramic, and combinations thereof.

13. The system of claim 1, wherein the third layer is formed from a material selected from the group consisting of: concrete, brick, cement, and combinations thereof.

14. The system of claim 1, wherein the system further comprises one or more walkway that can be moved into alignment with an entry aperture in the chute walls, e.g. by use of a hydraulic system.

15. The system of claim 1, wherein the chute further comprises a braking component located at or near the bottom end of the chute, the braking component being configured to stop a capsule when it is in alignment with the exit aperture.

16. The system of claim 15, wherein the braking component is selected from the group consisting of: one or more permanent magnet having the opposite polarity to the lower magnets of the capsule; a spring plate; a hydraulicly sprung plate; and combinations thereof.

17. The system of claim 1, wherein the optional second layer is present.
